(19) United States
(12) Patent Application Publication
(10) Pub. No.: US 2025/0085992 A1
(43) Pub. Date: Mar. 13, 2025

(54) DISCOVER AND MODEL APPLICATIONS DEPLOYED IN CONTAINERIZED PLATFORMS

(71) Applicant: MICRO FOCUS LLC, SANTA CLARA, CA (US)

(72) Inventors: Lei Xiao, Shanghai (CN); Die Liu, Shanghai (CN); Jun-Wu Pan, Shanghai (CN); Yi Gong, Shanghai (CN)

(73) Assignee: MICRO FOCUS LLC, SANTA CLARA, CA (US)

(21) Appl. No.: 18/367,453

(22) Filed: Sep. 12, 2023

(51) Int. Cl. G06F 9/455

(52) U.S. Cl. CPC G06F 9/45558; G06F 2009/45583

(57) ABSTRACT

Containerized platforms like Kubernetes, OpenShift, EKS (Elastic Kubernetes Service), etc., containerize and orchestrate applications. There are mature solutions for discovering and modeling applications running in physical and virtualized machines, and for containerized platforms, there are solutions for discovering and modeling infrastructure like namespaces, controllers, and pods. While beneficial, such models are incomplete. Accordingly, systems and methods are provided herein for discovering applications and modeling resources utilized for the applications or product suites. As a result, version mismatches or unplanned changes may be detected and corrected.

### FIELD OF THE DISCLOSURE

The invention relates generally to systems and methods for automatically discovering resources and particularly to discovering resources utilized in a containerized (Kubernetes) deployed application.

### BACKGROUND

Application containers, such as those provided by Kubernetes, encapsulate processes and package dependencies. Kubernetes provides container-orchestration capability automating application deployment and Helm as the package manager, which manages complex Kubernetes applications. The number of applications deployed using Kubernetes and Helm continues to increase in popularity. Enterprise environments often run a great many applications, which brings challenges to information technology (IT) governance regarding what applications are installed and running. Without a clear picture of these application, it is difficult to ensure security and policy compliance.

Universal Discovery (UD) is a market leading discovery tool that provides application discovery capability for installed software and running software that has been deployed by “classic” installers on either physical or virtual machines. When applications run on containerized platforms, UD provides the infrastructure discovery but not application discovery. As a result, it may be possible to determine which versions of applications and product suites are running inside a containerized platform. Similarly, components in an application or product suite may not be visible or discoverable.

This document builds upon, but is not limited to, Kubernetes and Helm, as they are known prior to the filing of this application, and each of the following documents are incorporated herein by reference:
“Kubernetes Documentation” (available at: www.kubernetes.io/docs/com);
“Helm: The packages manager for Kubernetes” (available at: www.helm.sh/);
“Resource: helm_release” (available at: www.registry.terraform.io/providers/hashicorp/helm/latest/docs/resources/release);
“Kubernetes discovery” (available at: www.docs.microfocus.com/doc/Universal_Discovery_Content_Pack/2023.02/Kubernetes); and
“Configuration item” (available at en.wikipedia.org/wiki/Configuration_item).

### SUMMARY

These and other needs are addressed by the various embodiments and configurations of the present invention. The present invention can provide a number of advantages depending on the particular configuration. These and other advantages will be apparent from the disclosure of the invention(s) contained herein.

Embodiments described herein are generally directed to a novel Universal Discovery (UD) that is able to discover Helm-based deployed applications in containerized platforms. Additional embodiments further detect unplanned changes or version mismatches and execute responses to the unplanned changes or version mismatches.

In one embodiment, an enhancement is made to the existing containerized platform discovery to provide discovery applications or product suites running inside containerized platforms. The enhancement uses representational state transfer (RESTful) application programming interface (API). The RESTful API of a containerized platform does not need to interact with the Helm client in order to discover the application deployments (e.g., Helm releases), the components (e.g., Helm charts) in application deployment, links between the applications and the infrastructure comprising containerized platforms.

In other embodiments, enhanced containerized platform discovery is provided to discover Helm charts and Helm releases and link to the relevant deployment, replica set, ingress, service, statefulset, daemonset, etc.

When deploying applications using Helm, auto-generated secrets are created in the target containerized platforms. All the metadata of the applications are stored in the encoded and compressed secrets. In another embodiment, the secrets are obtained using the restful API to get the secrets from the containerized platforms. The secrets are then decoded and/or decompressed in order to obtain the metadata of the applications. The metadata is parsed for key elements and the parsed data converted from the metadata to configuration items which are then linked with the infrastructure's namespaces, controllers, pods, etc. As a result, a topological graph may be created that represents the applications, applications' components, and relationships between the applications and infrastructure.

The discovery includes the below steps.
(i) List all the Helm related secrets, such as by using the label filters:
   i. type=helm.sh/release.v1
   ii. status=deployed
(ii) Decode the secrets using a decoding library (e.g., base64) which then returns compressed binary data.
(iii) Decompress the compressed binary data using an unzip library (e.g., gzip) which then returns a Java Script Object Notation (JSON) string.
(iv) Parse the JSON string to obtain application information and infrastructure which are then converted into configuration data.

In another embodiment, the embodiments described herein may detect an unplanned change or a version mismatch. In response, the executing system may notify a user and/or automatically perform a mitigating action. For example, the executing system may call an API to create a change request according to the discovered information. The change request may then trigger a task (or a task in an integrated continuous integration and continuous delivery (CICD) system) to upgrade the lower version of a Helm chart to the higher version or revert the unplanned version changes in the task flow it contains. Tasks include, but are not limited to, deploying the Helm release with the upgraded chart; triggering all of the automation tests against the new Helm release environment, and if the tests pass, then building/generating a helm release version automatically; triggering a task to deploy/upgrade the new Helm release version automatically; triggering UD to rediscover the target containerized platform to populate the latest information of the charts; and/or the UD checking if the versions are aligned automatically, and if aligned, calling the API to close the change request.

In some aspects, the techniques described herein relate to a computer-implemented method, including: accessing a first resource from a containerized platform; decoding the first resource into metadata; parsing the metadata into related configuration items; and determining relationship links between the related configuration items to create an application model.

In some aspects, the techniques described herein relate to a computer-implemented method, wherein accessing the first resource from the containerized platform includes obtaining a listing of Helm secrets returned by querying the first resource from the containerized platform with filters, the filters including “type=helm.sh/release.v1” and “status=deployed”.

In some aspects, the techniques described herein relate to a computer-implemented method, wherein decoding the first resource into metadata includes decoding the first resource utilizing a decoding library provided with the first resource and obtaining, as an output from the decoding library, compressed binary metadata.

In some aspects, the techniques described herein relate to a computer-implemented method, further including decompressing the compressed binary metadata with a decompression library and receiving therefrom a JavaScript Object Notation string (JSON string).

In some aspects, the techniques described herein relate to a computer-implemented method, wherein determining the relationship links between the related configuration items to create the application model further includes parsing the JSON string and obtaining therefrom application data and infrastructure data.

In some aspects, the techniques described herein relate to a computer-implemented method, further including converting the application data and the infrastructure data into configuration data and relationship links interconnecting the related configuration items.

In some aspects, the techniques described herein relate to a computer-implemented method, wherein the containerized platform includes a container orchestrator selected from a group of container orchestrators including Kubernetes, OpenShift by Red Hat, Tanzu by VMware, Docker Community Edition, Docket Enterprise Edition, and SUSE CaaS platform.

In some aspects, the techniques described herein relate to a computer-implemented method, further including comparing the application model with a reference model to determine differences therebetween and, upon the differences being non-null, performing a restorative action.

In some aspects, the techniques described herein relate to a computer-implemented method, wherein the restorative action includes initiating an application programming interface (API) call to the containerized platform to deploy a template to attenuate the differences between the reference model and the application model.

In some aspects, the techniques described herein relate to a computer-implemented method, further including automatically performing a test to determine if the API call has attenuated the differences between the reference model and the application model and, if successful, generating a new template release.

In some aspects, the techniques described herein relate to a system, including: at least one processor, wherein each processor thereof is coupled to a computer memory, the computer memory including instructions that cause the at least one processor to perform: accessing a first resource from a containerized platform; decoding the first resource into metadata; parsing the metadata into related configuration items; and determining relationship links between the related configuration items to create an application model.

In some aspects, the techniques described herein relate to a system, wherein accessing the first resource from the containerized platform includes obtaining a listing of Helm secrets returned by querying the first resource from the containerized platform with filters, the filters including “type=helm.sh/release.v1” and “status=deployed”.

In some aspects, the techniques described herein relate to a system, wherein decoding the first resource into metadata includes decoding the first resource utilizing a decoding library provided with the first resource and obtaining, as an output from the decoding library, compressed binary metadata.

In some aspects, the techniques described herein relate to a system, further including decompressing the compressed binary metadata with a decompression library and receiving therefrom a JavaScript Object Notation string (JSON string).

In some aspects, the techniques described herein relate to a system, wherein determining the relationship links between the related configuration items to create the application model further includes parsing the JSON string and obtaining therefrom application data and infrastructure data.

In some aspects, the techniques described herein relate to a system, further including instructions to cause the at least one processor to perform converting the application data and the infrastructure data into configuration data and relationship links interconnecting the related configuration items.

In some aspects, the techniques described herein relate to a system, wherein the containerized platform includes a container orchestrator selected from a group of container orchestrators including Kubernetes, OpenShift by Red Hat, Tanzu by VMware, Docker Community Edition, Docket Enterprise Edition, and SUSE CaaS platform.

In some aspects, the techniques described herein relate to a system, further including instructions to cause the at least one processor to perform comparing the application model with a reference model to determine differences therebetween and, upon the differences being non-null, performing a restorative action.

In some aspects, the techniques described herein relate to a system, wherein the restorative action includes initiating an application programming interface (API) call to the containerized platform to deploy a template to attenuate the differences between the reference model and the application model.

In some aspects, the techniques described herein relate to a system, including: means to access a first resource from a containerized platform; means to decode the first resource into metadata; means to parse the metadata into related configuration items; and means to determine relationship links between the related configuration items to create an application model.

A system on a chip (SoC) including any one or more of the above aspects or aspects of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

The term “namespace,” as used herein, shall refer to the term as it is known within the Kubernetes documentation which generally refers to the mechanism(s) for isolating groups of resources within a single cluster. Names of resources need to be unique within a namespace, but not across namespaces. Namespace-based scoping is applicable only for namespaced objects (e.g. deployments, services, etc.) and not for cluster-wide objects (e.g. StorageClass, Nodes, PersistentVolumes, etc.).

The term “cluster,” as used herein, shall refer to the term as it is known within the Kubernetes documentation which generally refers to a set of nodes that run containerized applications.

The term “container” (and other forms of the word, such as “containerized”), as used herein, shall refer to the term as it is known within the Kubernetes documentation which generally refers to the packages that comprise an application and the application's dependencies and, if needed, necessary services.

The term “pod,” as used herein, shall refer to the term as it is known within the Kubernetes documentation which generally refers to the smallest execution unit within Kubernetes that encapsulates one or more applications.

The term “resource,” as used herein, shall refer to the term as it is known within the Kubernetes documentation which generally refers to an endpoint in the Kubernetes API that stores a collection of API objects of a certain kind; for example, the built-in pod resource contains a collection of pod objects. A custom resource is an extension of the Kubernetes API that is not necessarily available in a default Kubernetes installation.

The term “replica set,” as used herein, shall refer to the term as it is known within the Kubernetes documentation which generally refers to a Kubernetes object used to maintain a stable set of replicated pods running within a cluster at any given time.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a prior art Kubernetes architecture;

FIG. 2 depicts software component relationships in accordance with embodiments of the present disclosure;

FIG. 3 depicts a topology in accordance with embodiments of the present disclosure;

FIG. 4 depicts component relationships in accordance with embodiments of the present disclosure;

FIG. 5 depicts component relationships in accordance with embodiments of the present disclosure;

FIG. 6 depicts component relationships in accordance with embodiments of the present disclosure;

FIG. 7 depicts a process in accordance with embodiments of the present disclosure; and

FIG. 8 depicts a device in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

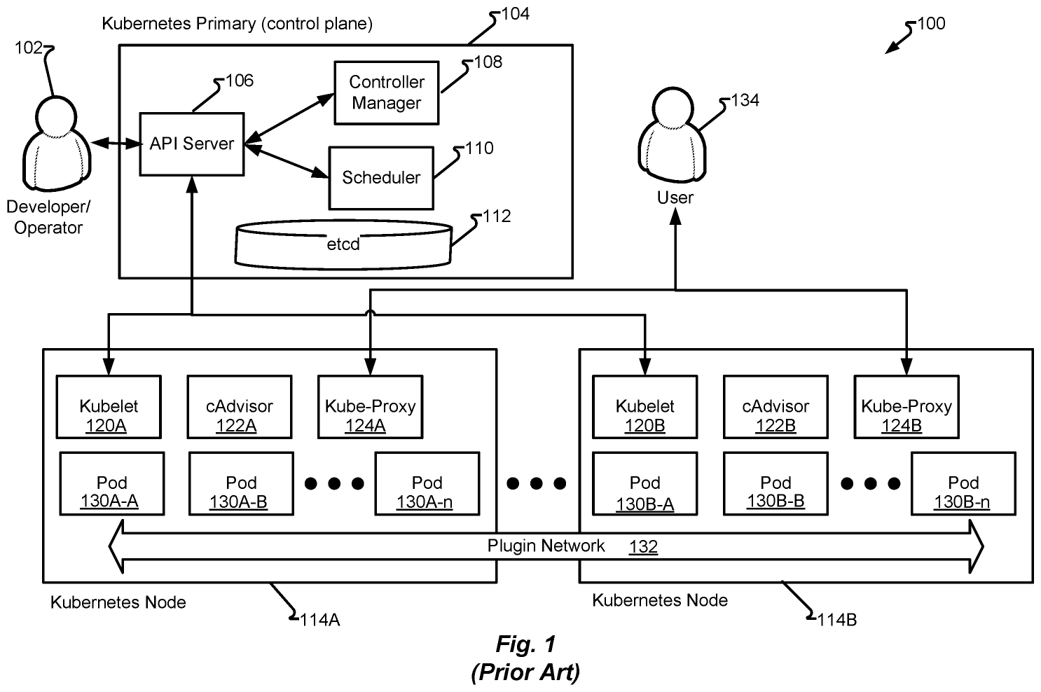

FIG. 1 depicts system 100 in accordance with the prior art. Developer/operator 102 interacts with Kubernetes primary (control plane) 104 via API server 106.

A Kubernetes cluster is a form of Kubernetes deployment architecture. Basic Kubernetes architecture exists in two parts: control plane 104 and at least one node 114 (one or more of nodes 114A-114B and optionally additional nodes not illustrated) or compute machines. While a single node 114 may be all that is required to be operational, two or more nodes 114 are generally utilized to provide robustness of the system and scalability. Each node 114 could be either a physical or virtual machine and is its own Linux environment. Every node 114 also runs pods 130 (e.g., ones of pods 130A-A through 130A-n and 130B-A through 130B-n), which are composed of containers.

Kubernetes architecture components include the Kubernetes control plane 104 and nodes 114 in the cluster. The control plane machine components include the Kubernetes API server 106, Kubernetes scheduler 110, Kubernetes controller-manager 108, and etcd 112. Kubernetes node 114 components include a container runtime engine or docker, a Kubelet service 120 (e.g., Kubelet 120A, Kubelet 120B, etc.), and a Kubernetes proxy service 124 (e.g., Kube-Proxy 124A, Kube-Proxy 124B, etc.). cAdvisor 122A, cAdvisor 122B are each an open-source agent that monitors resource usage and analyzes the performance of containers.

Control plane 104 is the nerve center that houses Kubernetes cluster architecture components that control the cluster. It also maintains a data record of the configuration and state of all of the cluster's Kubernetes objects.

Kubernetes control plane 104 is in constant contact with the compute machines (e.g., nodes 114) to ensure that the cluster runs as configured. Controllers (e.g., controller-manager 108) respond to cluster changes to manage object states and drive the actual, observed state or current status of system objects to match the desired state or specification.

Several major components comprise the control plane: the API server 106, scheduler 110, controller-manager 108, and etcd 112 are core components that ensure containers are running with the necessary resources and in sufficient numbers. The foregoing components may run on one primary node 104, but to ensure fault tolerance, primary nodes 114 may be replicated to achieve high availability.

Developer/operator 102 interacts with the Kubernetes architecture via API server 106 via an interface device (not shown). The front end of the Kubernetes control plane, API server 106, supports updates, scaling, and other kinds of lifecycle orchestration by providing APIs for various types of applications. Clients, such as developer/operator 102 via an interface device (not shown), must be able to access API server 134 from outside the cluster, which is the gateway, supporting lifecycle orchestration at each stage. In that role, clients use the API server 106 as a tunnel to pods 130, services running in the Kubernetes architecture, and nodes 114, and authenticate via the API server 106.

The Kubernetes scheduler 110 stores the resource usage data for each compute node 114; determines whether a cluster is healthy; and determines whether new containers should be deployed, and if so, where they should be placed. Scheduler 110 considers the health of the cluster generally alongside an individual pod's (e.g., pods 130) resource demands, such as a central processor unit (CPU) or memory. An appropriate compute node 114 is selected and schedules the task, pod 130, or service, taking resource limitations or guarantees, data locality, the quality of the service requirements, anti-affinity and affinity specifications, and other factors into account.

There are often various controllers (e.g., embodiments of controller-manager 108) in a Kubernetes ecosystem that drive the states of endpoints (pods 130 and services), tokens and service accounts (namespaces), nodes 114, and replication (autoscaling). Controller-manager 108—sometimes called cloud controller manager or simply controller—is a daemon which runs the Kubernetes cluster using several controller functions.

Controller-manager 108 watches the objects it manages (e.g., nodes 114, pods 130, etc.) in the cluster as it runs the Kubernetes core control loops. Controller-manager 108 observes objects for their desired state and current state via API server 106. If the current and desired states of the managed objects do not match, controller-manager 108 takes corrective steps to drive object status toward the desired state. Controller-manager 108 also performs core lifecycle functions.

Distributed and fault-tolerant, etcd 112 is an open source, key-value store database that stores configuration data and information about the state of the cluster, etcd 112 may be configured externally, although it is often part of Kubernetes control plane 104.

etcd 112 stores the cluster state based on the Raft consensus algorithm. This helps cope with a common problem that arises in the context of replicated state machines and involves multiple servers agreeing on values. Raft defines three different roles: leader, candidate, and follower, and achieves consensus by electing a leader.

In this way, etcd 112 acts as the single source of truth (SSOT) for all Kubernetes cluster components, responding to queries from control plane 104 and retrieving various parameters of the state of the containers, nodes 114, and pods 130, etcd 112 is also used to store configuration details such as ConfigMaps, subnets, and secrets, along with cluster state data.

Managed by control plane 104, cluster nodes 114 are machines that run containers. Each node 114 runs an agent for communicating with the control plane, Kubelet 120 (e.g., Kubelet 120A, Kubelet 120B, etc.)—the primary Kubernetes controller. Each node 114 comprises and runs a container runtime engine, such as Docker or rkt, and additional components for monitoring, logging, service discovery, and optional extras.

A Kubernetes cluster must have at least one compute node 114, although it may have many, depending on the need for capacity. Pods 130 are orchestrated and scheduled to run on nodes 114, so more nodes are needed to scale up cluster capacity.

Nodes 114 do the work for a Kubernetes cluster and connect applications and networking, compute, and storage resources. Nodes 114 may be cloud-native virtual machines (VMs) or bare metal servers in data centers.

Each compute node 114 runs and manages container life cycles using a container runtime engine (not shown). Kubernetes supports Open Container Initiative-compliant runtimes such as Docker, CRI-O, and rkt.

Each compute node 114 includes a kubelet 120, an agent that communicates with control plane 104 to ensure the containers in each pod 130 are running. When control plane 104 requires that a specific action happen in a node 114, the kubelet 120 receives the pod specifications through API server 106 and executes the action and ensures the associated containers are healthy and running.

Each compute node 114 contains a network proxy called a kube-proxy 124 that facilitates Kubernetes networking services. Kube-proxy 124 either forwards traffic itself or relies on the packet filtering layer of the operating system to handle network communications both outside and inside the cluster.

Kube-proxy 124 runs on each node to ensure that services are available to external parties and available to process individual host subnetting. Kube-proxy 124 serves as a network proxy and service load balancer on its node, managing the network routing for User Datagram Protocol (UDP) and Transmission Control Protocol (TCP) packets. Kube-proxy 124 routes traffic for all service endpoints.

Pods 130 are central to Kubernetes as outward facing constructs that developers (e.g., developer/operator 102) interact with. A single pod 130 represents a single instance of an application, and the simplest unit within the Kubernetes object model. However, pods 130 are central and crucial to Kubernetes. Each pod 130 is composed of a container or tightly coupled containers in a series that logically go together, along with rules that control how the containers run.

Pods 130 have a limited lifespan and eventually die after upgrading or scaling back down. However, although they are ephemeral, pods 130 can run stateful applications by connecting to persistent storage.

Pods 130 are also capable of horizontal autoscaling, meaning they can grow or shrink the number of instances running. They can also perform rolling updates and canary deployments.

Pods 130 run together on nodes 114 and share content and storage and can reach other pods 130 via localhost. Containers may span multiple machines, so pods 130 may as well. One node 114 can run multiple pods 130, each collecting multiple containers. Communication between nodes 114 is provided by plugin network 132.

The pod is the core unit of management in the Kubernetes ecosystem and acts as the logical boundary for containers that share resources and context. Differences in virtualization and containerization are mitigated by the pod grouping mechanism, which enables running multiple dependent processes together.

Achieve scaling in pods 130 at runtime by creating replica sets, which deliver availability by constantly maintaining a predefined set of pods 130, ensures that the deployment always runs the desired number. Services can expose a single pod or a replica set to external or internal consumers.

Services associate specific criteria with pods to enable their discovery. Pods 130 and services are associated through key-value pairs called selectors and labels. Any new match between a pod label and selector will be discovered automatically by the service.

Kubernetes manages an application's containers, but it can also manage a cluster's attached application data. Kubernetes users can request storage resources without knowing underlying storage infrastructure details.

A Kubernetes volume is a directory that is accessible to a pod, which may hold data. The contents of the volume, how it comes to be, and the medium that backs it are determined by the volume type. Persistent volumes (PVs) are specific to a cluster, are generally provisioned by an administrator, and are tied into an existing storage resource. PVs can therefore outlast a specific pod.

Kubernetes relies on container images that it stores in a container registry. It can be a third-party registry or one an organization configures.

Namespaces are virtual clusters inside a physical cluster. They are intended to provide virtually separated work environments for multiple users and teams, and prevent teams from hindering each other by limiting what Kubernetes objects they can access. At the pod level, Kubernetes containers within a pod can reach other ports via localhost and share their IP addresses and network namespaces.

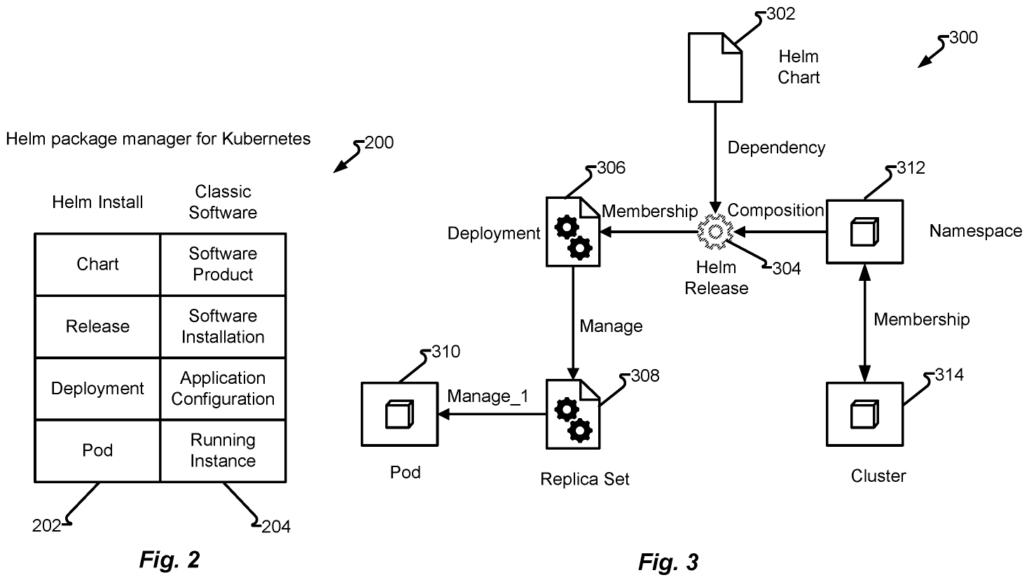

FIG. 2 depicts software component relationships 200 in accordance with embodiments of the present disclosure. Relationships 200 illustrate a mapping between containerized (Helm) components and classic (non-containerized) software applications. In one embodiment, relationships 200 illustrate a topology of discovered results and comprise entries in first column 202 and corresponding entries in second column 204.

FIG. 3 depicts topology 300 in accordance with embodiments of the present disclosure. In one embodiment, topology 300 is discovered and results from certain embodiments herein. Discovered results, and relationships therebetween, are depicted in topology 300 and include cluster 314 having membership of namespace 312. Namespace 312 is a composition of Helm release 304, which is dependent on Helm chart 302. Helm release 304 has a membership of deployment 306, which manages replica set 308. Replica set 308 manages pod 310.

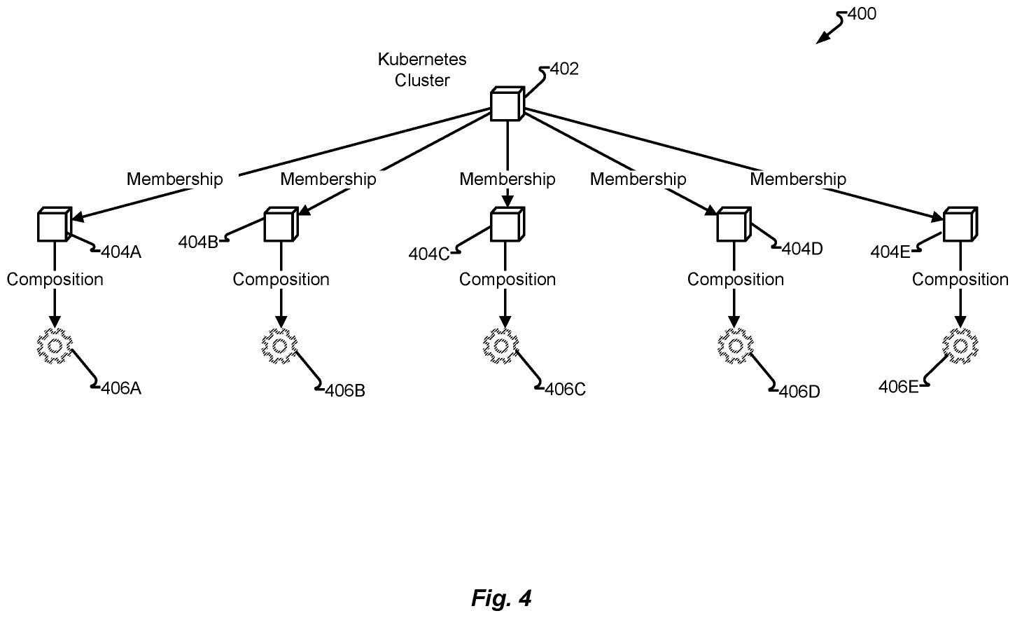

FIG. 4 depicts component relationships 400 in accordance with embodiments of the present disclosure. In one embodiment, relationships 400 are discovered for a particular application and comprise cluster 402 having membership comprising namespaces 404A-404E. Each namespace 404A-404E is a component of a corresponding Helm release 406A-406E.

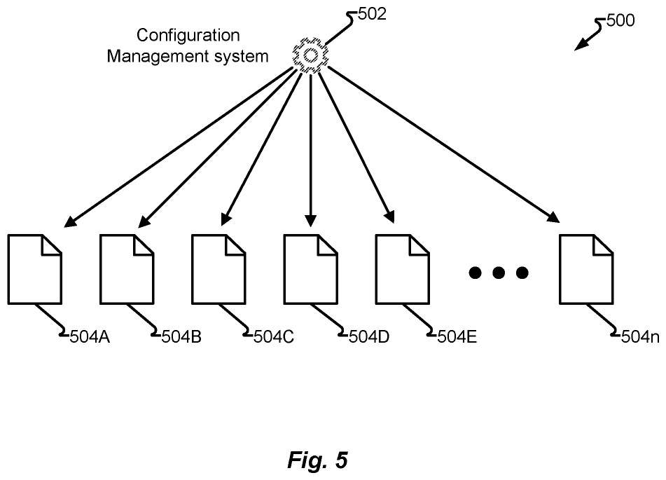

FIG. 5 depicts component relationships 500 in accordance with embodiments of the present disclosure. In one embodiment, relationships 500 are discovered for Helm chart 502 comprising a number of components 504A-504n. As is known in the art, one Helm chart represents one application or software, such as a database application.

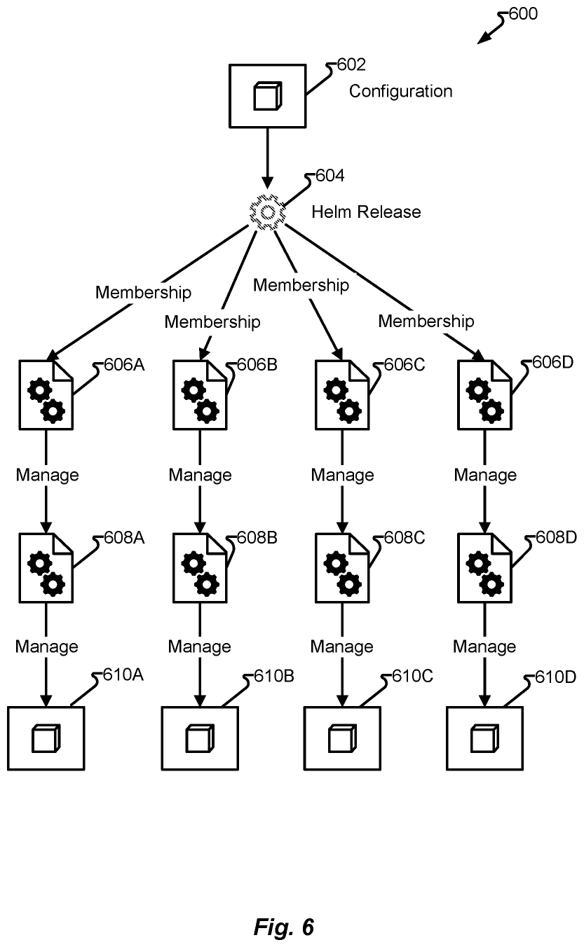

FIG. 6 depicts component relationships 600 in accordance with embodiments of the present disclosure. Relationship 600 illustrates a topology of a target environment comprising Kubernetes namespace 602 that composes Helm release 604, having membership of Kubernetes deployments 606A-606D, which manage replica sets 608A-608D, respectively, which manage pods 610A-610D, respectively.

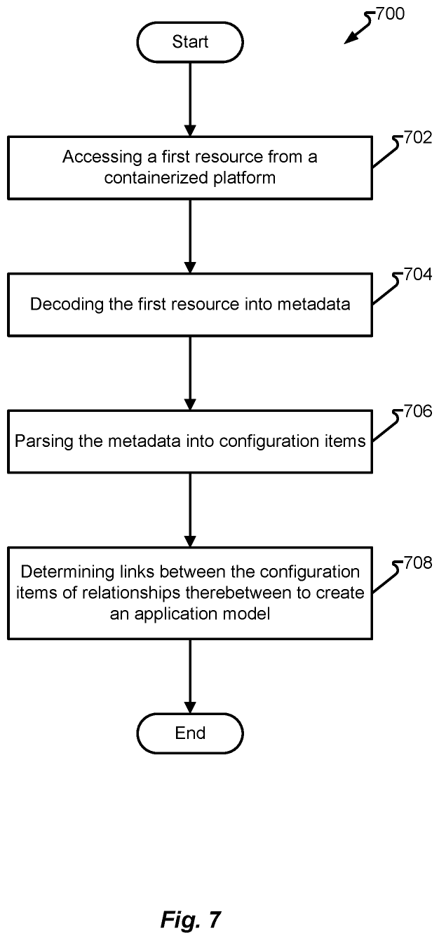

FIG. 7 depicts process 700 in accordance with embodiments of the present disclosure. In one embodiment, process 700 may be executed as a portion of an infrastructure discover tool, such as Universal Discovery by OpenText, such as to discover an application, namespace, or port name (each being a resource of Kubernetes). However, determining what application (or attributes of the application) are stored in a Kubernetes cluster is not provided in the prior art.

In another embodiment, process 700 begins and, in step 702, accesses a first resource from a containerized platform. The first resource may be referred to as a “secret.” The containerized platform comprises a Kubernetes, or similar orchestration platform, deployment of a software application. What is or is not a resource (e.g., the first resource) is variously embodied. Resources are the software and/or hardware components allocated and utilized by Kubernetes for the execution of an application executed by one or more Kubernetes pods. Notably, Helm release and Helm chart are utilized to specify a Kubernetes build but are not a Kubernetes resource. A Helm client may be utilized to obtain certain text-based descriptions of the specified Kubernetes build. That is, Kubernetes does not need Helm in order to execute any function. However, knowing the build (i.e., Helm chart) of an application, and the components' interrelationships, are provided by the embodiments herein. Knowing the actual resources used by an application allows those resources to be compared to a reference, such as an expected set of resources. If a difference is detected to exist between the actual and reference resources, a corrective action may be initiated, such as to automatically reload a reference to replace an incorrect version (or other attribute) with a reference version (or similar attribute).

Accessing the resource may comprise providing an access point, which is a RESTful API endpoint, via a URL with a credential and receiving therefrom the Kubernetes resources. The RESTful API may be queried with filters, such as, “type=helm.sh/release.v1” and “status=deployed”. The RESTful API returns encoded information, naming the first resource. In another embodiment, the resource may be a plurality of resources.

Step 704 decodes the first resource into metadata of the application. The metadata may include application name, application version, Helm Chart version, replica set, port, and/or other information. Step 704 may utilize a decoding library, such as base64, and receive therefrom compressed binary data. The compressed binary data may be decompressed (e.g., unzipped) by using a decompression library (e.g., gzip) and may receive configuration items therefrom, such as in the form of a JSON string. The configuration items may further comprise relationships (e.g., dependencies, utilization, management, etc.) between resources. The configuration items are known in the art and described in “en.wikipedia.org/wiki/Configuration_item.”

Step 706 parses the metadata into configuration items. Step 708 determines links between the configuration items of relationships therebetween to create an application model. As a result, a namespace may be linked to a Helm release and the Kubernetes resources. In doing so, the full topology of the application may be obtained. Optionally, the topology may be presented graphically (e.g., in a hierarchical tree structure) and/or evaluated for errors or unplanned changes against a reference and may correct any such errors or unplanned changes.

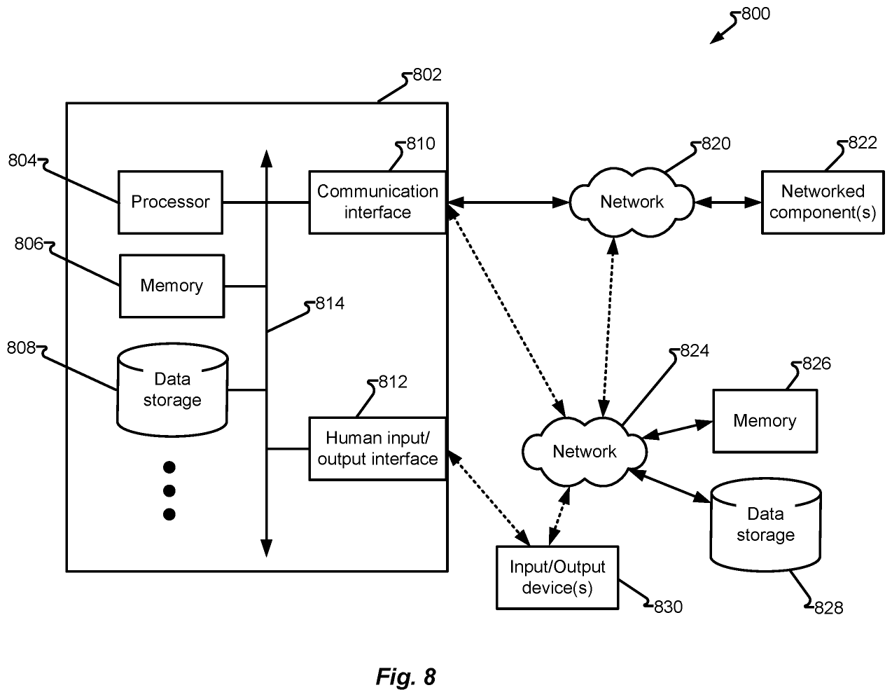

Process 700 may be embodied as machine-readable instructions maintained in a non-transitory memory that when read by a machine, such as processor(s) of a server, cause the machine to execute the instructions and thereby execute process 700. The processor of the server may include, but is not limited to, at least one processor of device 802 (see FIG. 8).

FIG. 8 depicts device 802 in system 800 in accordance with embodiments of the present disclosure. In one embodiment, device 802 comprising various components and connections to other components and/or systems. The components are variously embodied and may comprise processor 804. The term “processor,” as used herein, refers exclusively to electronic hardware components comprising electrical circuitry with connections (e.g., pin-outs) to convey encoded electrical signals to and from the electrical circuitry. Processor 804 may comprise programmable logic functionality, such as determined, at least in part, from accessing machine-readable instructions maintained in a non-transitory data storage, which may be embodied as circuitry, on-chip read-only memory, computer memory 806, data storage 808, etc., that cause the processor 804 to perform the steps of the instructions. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814. In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize computer memory 806 and/or data storage 808 for the storage of accessible data, such as instructions, values, etc. Network interface 810 facilitates communication with components, such as processor 804 via bus 814 with components not accessible via bus 814. Network interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, speaker, microphone, still and/or video camera, etc. In another embodiment, network interface 810 may comprise, or be comprised by, human input/output interface 812. Network interface 810 may be configured to communicate directly with a networked component or configured to utilize one or more networks, such as network 820 and/or network 824.

Network 820 may be a wired network (e.g., Ethernet), wireless (e.g., WiFi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.).

Additionally or alternatively, one or more other networks may be utilized. For example, network 824 may represent a second network, which may facilitate communication with components utilized by device 802. For example, network 824 may be an internal network to a business entity or other organization, whereby components are trusted (or at least more so) than networked components 822, which may be connected to network 820 comprising a public network (e.g., Internet) that may not be as trusted.

Components attached to network 824 may include computer memory 826, data storage 828, input/output device(s) 830, and/or other components that may be accessible to processor 804. For example, computer memory 826 and/or data storage 828 may supplement or supplant computer memory 806 and/or data storage 808 entirely or for a particular task or purpose. As another example, computer memory 826 and/or data storage 828 may be an external data repository (e.g., server farm, array, “cloud,” etc.) and enable device 802, and/or other devices, to access data thereon. Similarly, input/output device(s) 830 may be accessed by processor 804 via human input/output interface 812 and/or via network interface 810 either directly, via network 824, via network 820 alone (not shown), or via networks 824 and 820. Each of computer memory 806, data storage 808, computer memory 826, data storage 828 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 830 may be a router, a switch, a port, or other communication component such that a particular output of processor 804 enables (or disables) input/output device 830, which may be associated with network 820 and/or network 824, to allow (or disallow) communications between two or more nodes on network 820 and/or network 824. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A computer-implemented method, comprising:
accessing a first resource from a containerized platform;
decoding the first resource into metadata;
parsing the metadata into related configuration items; and
determining relationship links between the related configuration items to create an application model.

2. The computer-implemented method of claim 1, wherein accessing the first resource from the containerized platform comprises obtaining a listing of Helm secrets returned by querying the first resource from the containerized platform with filters, the filters comprising “type=helm.sh/release.v1” and “status=deployed”.

3. The computer-implemented method of claim 1, wherein decoding the first resource into metadata comprises decoding the first resource utilizing a decoding library provided with the first resource and obtaining, as an output from the decoding library, compressed binary metadata.

4. The computer-implemented method of claim 3, further comprising decompressing the compressed binary metadata with a decompression library and receiving therefrom a JavaScript Object Notation string (JSON string).

5. The computer-implemented method of claim 4, wherein determining the relationship links between the related configuration items to create the application model further comprises parsing the JSON string and obtaining therefrom application data and infrastructure data.

6. The computer-implemented method of claim 5, further comprising converting the application data and the infrastructure data into configuration data and relationship links interconnecting the related configuration items.

7. The computer-implemented method of claim 1, wherein the containerized platform comprises a container orchestrator selected from a group of container orchestrators comprising Kubernetes, OpenShift by Red Hat, Tanzu by VMware, Docker Community Edition, Docket Enterprise Edition, and SUSE CaaS platform.

8. The computer-implemented method of claim 1, further comprising comparing the application model with a reference model to determine differences therebetween and, upon the differences being non-null, performing a restorative action.

9. The computer-implemented method of claim 8, wherein the restorative action comprises initiating an application programming interface (API) call to the containerized platform to deploy a template to attenuate the differences between the reference model and the application model.

10. The computer-implemented method of claim 9, further comprising automatically performing a test to determine if the API call has attenuated the differences between the reference model and the application model and, if successful, generating a new template release.

11. A system, comprising:
at least one processor, wherein each processor thereof is coupled to a computer memory, the computer memory comprising instructions that cause the at least one processor to perform:
accessing a first resource from a containerized platform;
decoding the first resource into metadata;
parsing the metadata into related configuration items; and
determining relationship links between the related configuration items to create an application model.

12. The system of claim 11, wherein accessing the first resource from the containerized platform comprises obtaining a listing of Helm secrets returned by querying the first resource from the containerized platform with filters, the filters comprising “type=helm.sh/release.v1” and “status=deployed”.

13. The system of claim 11, wherein decoding the first resource into metadata comprises decoding the first resource utilizing a decoding library provided with the first resource and obtaining, as an output from the decoding library, compressed binary metadata.

14. The system of claim 13, further comprising decompressing the compressed binary metadata with a decompression library and receiving therefrom a JavaScript Object Notation string (JSON string).

15. The system of claim 14, wherein determining the relationship links between the related configuration items to create the application model further comprises parsing the JSON string and obtaining therefrom application data and infrastructure data.

16. The system of claim 15, further comprising instructions to cause the at least one processor to perform converting the application data and the infrastructure data into configuration data and relationship links interconnecting the related configuration items.

17. The system of claim 11, wherein the containerized platform comprises a container orchestrator selected from a group of container orchestrators comprising Kubernetes, OpenShift by Red Hat, Tanzu by VMware, Docker Community Edition, Docket Enterprise Edition, and SUSE CaaS platform.

18. The system of claim 11, further comprising instructions to cause the at least one processor to perform comparing the application model with a reference model to determine differences therebetween and, upon the differences being non-null, performing a restorative action.

19. The system of claim 18, wherein the restorative action comprises initiating an application programming interface (API) call to the containerized platform to deploy a template to attenuate the differences between the reference model and the application model.

20. A system, comprising:
means to access a first resource from a containerized platform;
means to decode the first resource into metadata;
means to parse the metadata into related configuration items; and
means to determine relationship links between the related configuration items to create an application model.
